(19) United States
(12) Patent Application Publication
(10) Pub. No.: US 2023/0385297 A1
(43) Pub. Date: Nov. 30, 2023

(54) INFORMATION MANAGEMENT APPARATUS, INFORMATION MANAGEMENT METHOD, AND RECORDING MEDIUM

(71) Applicant: Hitachi, Ltd., Tokyo (JP)

(72) Inventors: Garima NATANI, Tokyo (JP); Satoshi KATSUNUMA, Tokyo (JP); Toshihiko KASHIYAMA, Tokyo (JP)

(21) Appl. No.: 18/106,679

(22) Filed: Feb. 7, 2023

(30) Foreign Application Priority Data
May 26, 2022 (JP) 2022-086214

(51) Int. Cl. G06F 16/25; G06F 16/23

(52) U.S. Cl. CPC G06F 16/254; G06F 16/256; G06F 16/2379

(57) ABSTRACT

An information management apparatus is capable of reducing an effort for creating a rule for moving data stored in an OLTP database to an OLAP database, for example. A data movement optimization apparatus includes a table status update unit that acquires a table status in which data is stored for each of an OLTP database and an OLAP database selected from among a plurality of databases, a policy network learning unit that performs learning on the number of federated queries that are processing in which it is necessary to query both the OLTP database and the OLAP database for the table status, and a cost incurred when data is moved from the OLTP database to the OLAP database, and a data movement unit that performs control for moving data from the OLTP database to the OLAP database on the basis of a result of the learning and the table status.

### CROSS-REFERENCE TO RELATED APPLICATION

The present application claims priority from Japanese application JP2022-086214, filed on May 26, 2022, the contents of which is hereby incorporated by reference into this application.

### BACKGROUND OF THE INVENTION

### 1. Field of the Invention

The present invention relates to an information management apparatus, an information management method, and a recording medium. The present invention relates, particularly, to an information management apparatus suitable for management of a database that is used for hybrid transaction analytical processing (HTAP), or the like.

### 2. Description of the Related Art

In recent years, a workload in which there are both transaction processing and analytical processing has been increasing with rapid digitization. HTAP is an architecture that supports both the transaction processing and the analytical processing. In an HTAP architecture, for example, a database that is used for online transaction processing (OLTP) (hereinafter sometimes simply referred to as an “OLTP database”) and a database that is used for online analytical processing (OLAP) (hereinafter sometimes simply referred to as an “OLAP database”) are used. The OLTP database stores relatively recent data for fast transaction processing. On the other hand, the OLAP database stores a relatively long period of data for analytical processing. The data is moved from the OLTP database to the OLAP database.

US Patent Application Publication No. 2013/0024573 discloses a database management system. This database management system includes an OLTP processing unit, an OLAP processing unit, an SCM that stores row-oriented data for OLTP, and a memory management unit that accumulates a predetermined amount of data stored as row-oriented data after update performed by the OLTP on the SCM, stores the predetermined amount of accumulated data in a block on a column-by-column basis in a DRAM, and stores the block on a column-by-column basis in a disk for OLAP.

### SUMMARY OF THE INVENTION

However, it takes a predetermined time for the data stored in the OLTP database to be moved to the OLAP database. Therefore, when there are queries (federated queries) that perform analytical processing on the data stored in the OLTP database, a task for temporarily moving the data from the OLTP database to the OLAP database before periodic movement of the data is required. This task is a costly process. Therefore, in order to reduce the number of federated queries, it is preferable to define a rule for moving the data stored in the OLTP database to the OLAP database, and move the data according to this rule. However, a status of the database is dynamically changing, and under this condition, it takes a lot of effort for the database administrator to design a rule for moving the data.

An object of the present invention is to provide an information management apparatus, an information management method, and a recording medium capable of reducing an effort for creating a rule for moving data stored in a first database (for example, an OLTP database) to a second database (for example, an OLAP database).

In order to solve the above problem, the present invention provides an information management apparatus including: an acquisition unit configured to acquire a status in which data is stored, for each of a first database and a second database selected from among a plurality of databases; a learning unit configured to perform learning on a number of federated queries, the federated queries being processing in which it is necessary to query both the first database and the second database, and a cost incurred when data is moved from the first database to the second database, for the status; and a movement unit configured to perform control for moving data from the first database to the second database on the basis of a result of the learning and the status.

Further, the present invention provides an information management method including: acquiring a status in which data is stored, for each of a first database and a second database selected from among a plurality of databases; performing learning on the number of federated queries, the federated queries being processing in which it is necessary to query both the first database and the second database, and a cost incurred when data is moved from the first database to the second database, for the status; and performing control for moving data from the first database to the second database on the basis of a result of the learning and the status.

Further, the present invention provides a computer-readable recording medium having a program recorded thereon, the program causing a computer to realize: an acquisition function of acquiring a status in which data is stored, for each of a first database and a second database selected from among a plurality of databases; a learning function of performing learning on the number of federated queries, the federated queries being processing in which it is necessary to query both the first database and the second database, and a cost incurred when data is moved from the first database to the second database, for the status; and a movement function of performing control for moving data from the first database to the second database on the basis of a result of the learning and the status.

According to the invention according to claim 1, it is possible to provide an information management apparatus capable of reducing an effort for creating a rule for moving data stored in a first database (for example, an OLTP database) to a second database (for example, an OLAP database).

According to the invention according to claim 2, it is possible to perform machine learning for a case in which the number of federated queries or the cost decreases, by considering a reward when the movement of the data is performed from the first database to the second database.

According to the invention according to claim 3, it is possible to perform machine learning more efficiently.

According to the invention according to claim 4, it is possible to set an appropriate value as the reward.

According to the invention according to claim 5, it is possible to perform the movement of the data when the number of federated queries or the cost is expected to decrease.

According to the invention according to claim 6, it is possible to select a more appropriate target for cost calculation.

According to the invention according to claim 7, it is possible to select a more appropriate status of the first database and the second database.

According to the invention according to claim 8, it is possible to express the recording period more simply.

According to the invention according to claim 9, it is possible to reduce an effort for creating a rule for moving the data stored in the OLTP database to the OLAP database.

According to the invention according to claim 10, it is possible to specify content of the federated query.

According to the invention according to claim 11, it is possible to reduce the number of federated queries or the cost for a system operating on the HTAP architecture.

According to the invention according to claim 12, it is possible to provide an information management method capable of reducing an effort for creating a rule for moving data stored in a first database (for example, an OLTP database) to a second database (for example, an OLAP database).

According to the invention according to claim 13, it is possible to realize, using a computer, a function capable of reducing an effort for creating a rule for moving data stored in a first database (for example, an OLTP database) to a second database (for example, an OLAP database).

### BRIEF DESCRIPTION OF THE DRAWINGS

FIG. 1 is a diagram illustrating a configuration example of an information processing system according to the present embodiment;

FIG. 2 is a diagram illustrating a case in which federated queries occur;

FIG. 3 is a diagram illustrating a procedure of a task that a database administrator performs when creating a rule for performing movement of data;

FIG. 4 is a block diagram illustrating a functional configuration of the information processing system;

FIG. 5 is a diagram illustrating a schematic operation of the information processing system;

FIG. 6 is a diagram illustrating the procedure by which a data movement optimization apparatus performs deep machine learning on the basis of a table status;

FIG. 7 is a diagram illustrating an artificial neural network that is used to perform deep machine learning;

FIG. 8 is a diagram illustrating parameters that are used when a cost is obtained;

FIG. 9 is a flowchart illustrating an action of the data movement optimization apparatus when data is moved from an OLTP database to an OLAP database using a policy network;

FIG. 10 is a flowchart illustrating a flow when the policy network performs learning;

FIG. 11 is a flow chart illustrating a flow when the policy network performs learning;

FIG. 12 is a diagram illustrating flow chart 3 of step S1006 in FIG. 10 in greater detail;

FIG. 13 is a diagram illustrating flow chart 4 in step S1011 of FIG. 10 in greater detail; and

FIG. 14 is a diagram illustrating flow chart 5 in step S1009 of FIG. 10 in greater detail.

### DESCRIPTION OF THE PREFERRED EMBODIMENTS

Hereinafter, embodiments of the present invention will be described in detail with reference to the accompanying drawings.

Description of Entire Information Processing System 1

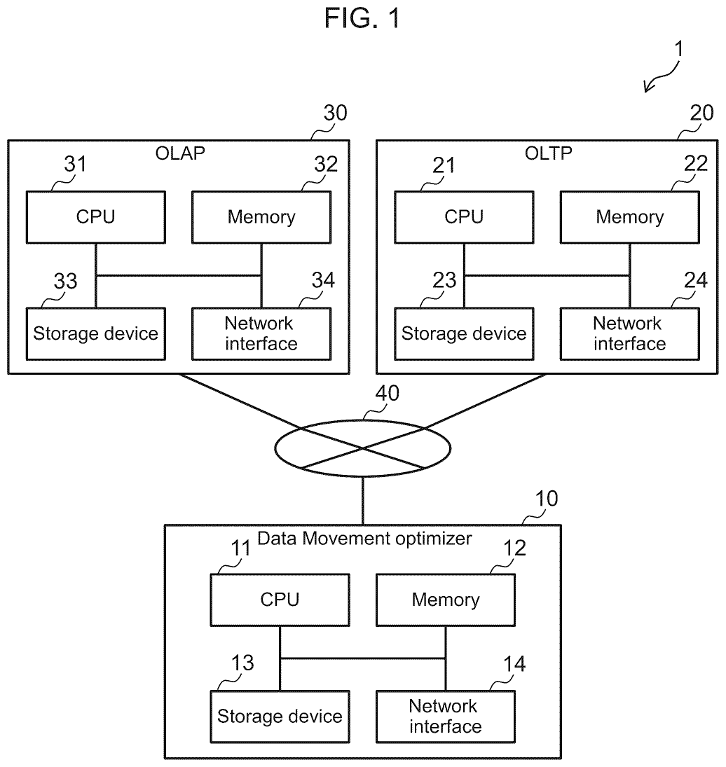

FIG. 1 is a diagram illustrating a configuration example of an information processing system 1 according to the present embodiment.

As illustrated, in the information processing system 1 of the present embodiment, a data movement optimization apparatus (Data Movement optimizer) 10, an OLTP system (OLTP) 20, and an OLAT system (OLAP) 30 are connected via a network 40.

The data movement optimization apparatus 10 is an example of an information management apparatus, and is a server computer that performs data management of the OLTP system 20 and the OLAP system 30. The data movement optimization apparatus 10 manages movement of data from the OLTP system 20 to the OLAP system 30 as described above. More specifically, a timing at which data is moved from the OLTP system 20 to the OLAP system 30 is determined.

The OLTP system 20 is a server computer including an OLTP database. In the present embodiment, the OLTP database is an example of a first database, and is a database that is used when OLTP is performed. The OLTP system 20 performs transaction processing in real time (online) according to a request from a user. In the OLTP system 20, excellent high-speed processing of small-scale data is required. Therefore, the OLAP database is fast when reading data. Since the OLTP system 20 puts emphasis on performance, the OLTP database handles only a recent history. It can be said that a recording period of the data stored in the OLTP database is relatively short. In the OLTP database, recent data is typically stored and updated in real time, and high concurrency and strong consistency are supported. The OLTP system 20 puts emphasis on very fast query processing, with a few rows of data that is changed with each request. Thus, the OLTP database is often a row-oriented database.

The OLAP system 30 is a server computer including an OLAP database. In the present embodiment, the OLAP database is an example of a second database, and is a database that is used when OLAP is performed. The OLAP system 30 performs analytical processing in real time (online) according to a request from the user. The OLAP system 30 is required to handle a large amount of data. Therefore, it is necessary for the OLAP database to be a database that stores a large amount of data. Therefore, the OLTP database handles a relatively long period of history. It can be said that the recording period of the data stored in the OLAP database is relatively long. Further, in the OLAP database, past data is stored with more emphasis than recent data. The OLAP database is a database that handles history data with a small amount of transactions, and since the history data is processed by batch processing, concurrency is not high. A number of rows are handled in one request. Therefore, the OLAP database is often a column-oriented database.

Although one data movement optimization apparatus 10, one OLTP system 20, and one OLAP system 30 have been illustrated, functions thereof may be realized by a plurality of server computers. Further, the data movement optimization apparatus 10, the OLTP system 20, and the OLAP system are server computers, but these are not limited thereto and may be computer devices such as general-purpose personal computers (PCs), mobile computers, mobile phones, smartphones, and tablets.

The data movement optimization apparatus 10, the OLTP system 20, and the OLAP system 30 have similar hardware configurations. That is, the data movement optimization apparatus 10 includes a central processing unit (CPU) 11, a memory 12, a storage device 13, and a network interface 14. Similarly, the OLTP system 20 includes a CPU 21, a memory 22, a storage device 23, and a network interface 24. Further, the OLAP system 30 includes a CPU 31, a memory 32, a storage device 33, and a network interface 34.

The CPUs 11, 21, and 31 execute programs such as an OS (basic software) or application software. The memories 12, 22, and 32 include a read only memory (ROM) having a basic input output system (BIOS) and the like stored therein, and a random access memory (RAM) used as a main storage device.

The storage devices 13, 23, and 33 are, for example, hard disk drives (HDDs) or solid state drives (SSDs), and store application software and the like. Further, data in the OLTP database is stored in the storage device 23, and data in the OLAP database is stored in the storage device 33.

The network interfaces 14, 24, and 34 are communication modules for performing communication with an external apparatus.

Further, the data movement optimization apparatus 10, the OLTP system 20, and the OLAP system 30 may include an output device. An example of the output device may include a display that displays images, and other information. The data movement optimization apparatus 10, the OLTP system 20, and the OLAP system 30 may also include an input device. An example of the input device may include a keyboard that inputs characters or the like, and a pointing device such as a mouse.

The network 40 is communication means that is used for data communication between the data movement optimization apparatus 10, the OLTP system 20, and the OLAP system 30, and is, for example, the Internet, a local area network (LAN), or a wide area network (WAN). A communication line that is used for data communication may be wired or wireless, and both may be used. Further, the data movement optimization apparatus 10, the OLTP system 20, and the OLAP system 30 may be connected via a plurality of networks or communication lines using a relay device such as a gateway device or a router.

Overview of Operation of Information Processing System 1

The information processing system 1 operates under the HTAP architecture. In the HTAP architecture, both transaction processing and analytical processing are supported, and both processing can be performed according to a request from the user. Therefore, when the request from the user is for transaction processing, processing is performed through an application software that performs transaction processing using the OLTP system 20. Further, when the request from the user is for analytical processing, processing is performed through application software that performs analytical processing using the OLAP system 30. Further, as described above, the OLTAP database stores recent data, and the OLTP database stores data with emphasis on past data rather than the recent data. Therefore, in the HTAP architecture, it is necessary to perform movement of data from the OLTP database to the OLAP database. There is a method of performing the movement periodically, such as every day or every year as a timing at which the movement of the data is performed. However, a cost is incurred for movement of data. Here, the “cost” is, for example, a cost incurred for use of the CPUs 11 and 21, a cost incurred for reading or writing of data from or to the OLTP database or the OLAP database, and a cost incurred for communication using the network 40. Among these, a cost incurred for writing of data is particularly high.

Further, since only relatively old data is stored in the OLAP database, querying data earlier than a period of data stored in the OLAP database is sometimes desired at the time of analytical processing. That is, since the OLTP database includes earlier data than that of the OLAP database, it is possible to perform analytical processing on more recent data by using the data in the OLTP database. However, in this case, queries (federated queries) that perform analytical processing on the data stored in the OLTP database occur. This is processing in which querying both the OLTP and OLAP databases is required.

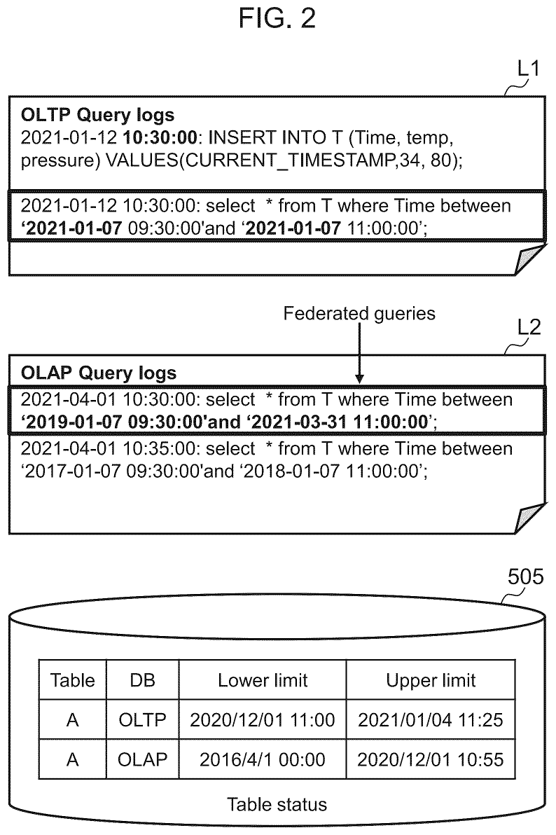

FIG. 2 is a diagram illustrating a case in which federated queries occur.

Here, query logs for the OLTP database (OLTP Query logs) L1, query logs for the OLAP database (OLAP Query logs) L2, and a table status (Table Status) 505 are shown. The table status 505, which will be described below in detail, is a table representing a status at which data in the OLTP database or the OLTAP database is stored. The table status includes, as this status, information on the recording period of the data stored in each of the OLTP database and the OLTAP database. The “recording period” can be represented by a date and time when each stored piece of data has been generated. That is, the recording period is represented by a date and time of the oldest data and a date and time of the most recent (newest) data. That is, the recording period indicates that data during a period between these two date and times is recorded.

Here, it can be seen from the logs L2 that a period of analytical processing requested by one query is from 2019-01-07 09:30:00 (09:30 on Jan. 7, 2019) to 2021-03-31 11:00:00 (11:00 on Mar. 31, 2021).

According to the table status 505 in this case, the recording period of the data of the OLAP database is only until 2020/12/01 10:55 (10:55 on Dec. 1, 2020). Therefore, it is necessary for data before this date and time to be moved from the OLTP database. In this case, it is necessary for data from 2020/12/01 11:00 (11:00 on Dec. 1, 2020) to 2021-01-04 11:25:00 (11:25 on Jan. 4, 2021) to be moved from the OLTP database to the OLAP database. That is, it is necessary for all data in the OLTP database to be moved to the OLAP database.

When the federated queries occur, a task for temporarily moving necessary data from the OLTP database to the OLAP database is required. Since this task is costly, fewer federated queries are preferable. The number of federated queries decreases as a frequency at which movement of data from the OLTP database to the OLAP database is performed increases. However, the movement of the data is costly, as described above. On the other hand, the cost becomes lower as the frequency at which the movement of the data is performed decreases, but it becomes easy for the federated queries to occur.

From the above, in order to reduce the number of federated queries or the cost, it is preferable to perform the movement of the data dynamically, rather than adopting a method of periodically performing the movement as a timing at which the movement of the data is performed. That is, in order to reduce the number of federated queries or the cost, it is preferable to perform processing for performing the movement of the data, for example, irregularly according to the status of the OLTP database and the OLAP database, rather than periodically. In the related art, a database administrator creates a rule for performing movement of data, and determines the timing at which the movement of the data is performed, according to this rule.

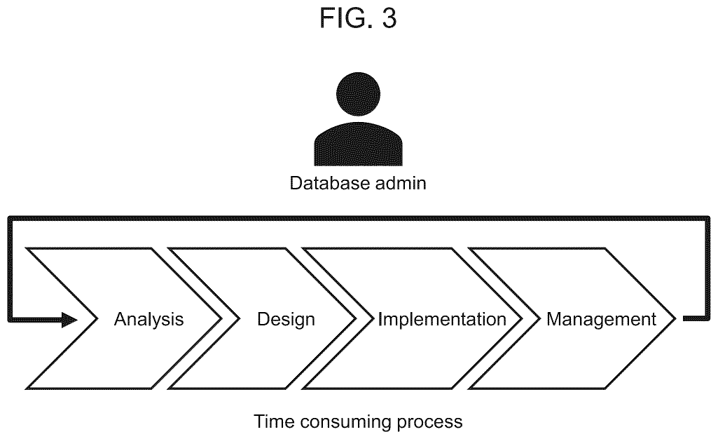

FIG. 3 is a diagram illustrating a procedure of a task that the database administrator performs when creating the rule for performing movement of data.

The database administrator (Database Admin) needs respective steps of analysis, design, implementation, and management.

In the “analysis”, the database administrator observes and analyzes query logs over a plurality of days. Accordingly, the database administrator needs to understand data movement requirements according to the newness of the data in the OLTP database and the OLP database. In the “design”, the database administrator converts these requirements into a rule design for improving the performance of the information processing system 1. In the “implementation”, code is created according to the rule design, and a test verifies that the rule meets the requirements. After the verification, this rule is implemented. Further, in the “management”, the movement of the data is performed according to this rule, but after a while, the requirements change and the rule needs to be updated.

That is, the database administrator needs to perform a complicated task when creating the rule for performing movement of data, requiring lots of effort and time.

Therefore, in the present embodiment, the data movement optimization apparatus 10 learns a case in which the number of federated queries or the cost when movement of data is performed using deep machine learning decreases. The data movement optimization apparatus 10 determines the timing at which the movement of the data is performed, on the basis of the learning model created by a result of the learning to solve the above problem. In order to realize this, in the present embodiment, the data movement optimization apparatus 10 has the following configuration.

Description of Functional Configuration of Information Processing System 1

Next, a functional configuration of the information processing system 1 will be described.

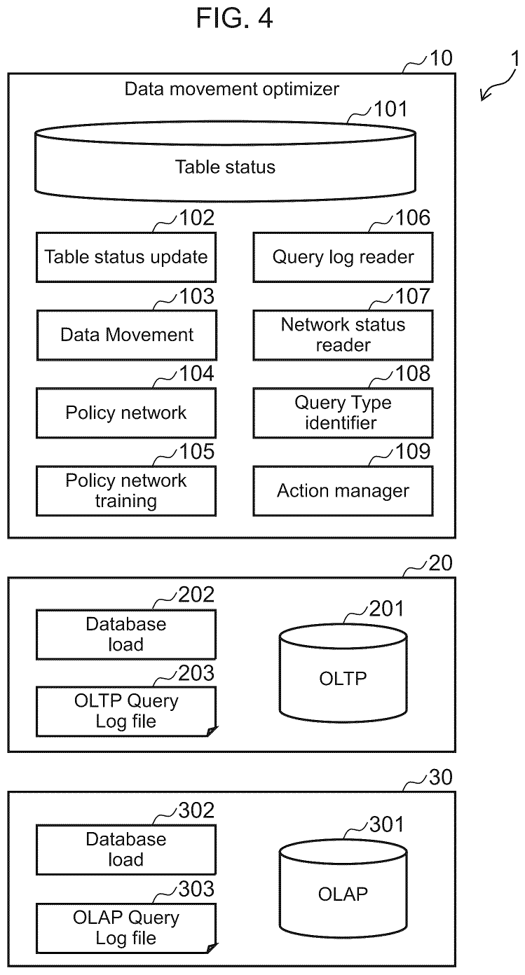

FIG. 4 is a block diagram illustrating the functional configuration of the information processing system 1.

Here, respective functional configuration examples of the data movement optimization apparatus (Data Movement optimizer) the OLTP system 20, and the OLAP system 30 are shown.

The data movement optimization apparatus 10 includes a table status storage unit (Table status) 101, a table status update unit (Table status update) 102, a data movement unit (Data movement) 103, a policy network unit (Policy network) 104, a policy network training unit (Policy network training) 105, a query log reading unit (Query log reader) 106, a network status reading unit (Network status reader) 107, a query type identification unit (Query Type identifier) 108, and an action management unit (Action manager) 109.

Further, the OLTP system 20 includes an OLTP database (OLTP) 201, a database load acquisition unit (Database load) 202, and an OLTP query log storage unit (OLTP Query Log file) 203.

Further, the OLAP system 30 includes an OLAP database (OLAP) 301, a database load acquisition unit (Database load) 302, and an OLAP query log storage unit (OLAP Query Log file) 303.

The table status storage unit 101 stores the table status 505.

The table status update unit 102 updates the table status 505. That is, when new data is stored in the OLTP database or the OLTAP database, the above-described recording period and the like change. Accordingly, the table status update unit 102 updates the table status 505 accordingly. The table status update unit 102 functions as an acquisition unit that acquires a data storage status for each of the OLTP database and the OLTAP database.

The data movement unit 103 is an example of a movement unit, and performs control for moving data from the OLTP database to the OLTAP database on the basis of a result of learning and the table status 505. That is, the data movement unit 103 dynamically moves the data from the OLTP database to the OLTAP database at a predetermined timing, as described above. Further, the data movement unit 103 temporarily moves necessary data from the OLTP database to the OLAP database when the federated queries occur.

The policy network unit 104 stores the learning model learned by a policy network learning unit 105. Here, this learning model is called a policy network.

The policy network learning unit 105 is an example of a learning unit. The policy network learning unit 105 performs learning for the number of federated queries for the table status 505 and the cost incurred when data is moved from the OLTP database to the OLTAP database. Although the details will be described below, the policy network learning unit 105 performs learning through deep machine learning.

The query log reading unit 106 records a log of queries requested by a user.

The network status reading unit 107 acquires a status of communication of the network 40. In this case, the status of communication when data is moved from the OLTP database to the OLTAP database is acquired.

The query type identification unit 108 identifies a type of query requested from the user. That is, the query type identification unit 108 identifies whether the type is online transaction processing (OLTP) performed by the OLTP system 20 or online analytical processing (OLAP) performed by the OLAP system 30.

The action management unit 109 manages an entire action of the data movement optimization apparatus 10.

The OLTP database 201 is a database that is used when the online transaction processing (OLTP) is performed, as described above.

The database load acquisition unit 202 acquires a load on the OLTP database 201.

The OLTP query log storage unit 203 stores logs of queries for performing the online transaction processing (OLTP).

The OLAP database 301 is a database that is used when the online analytical processing (OLAP) is performed, as described above.

The database load acquisition unit 302 acquires the load on the OLAP database 301.

The OLAP query log storage unit 303 stores logs of queries to be subjected to the online analytical processing (OLAP).

Description of Schematic Operation of Information Processing System 1

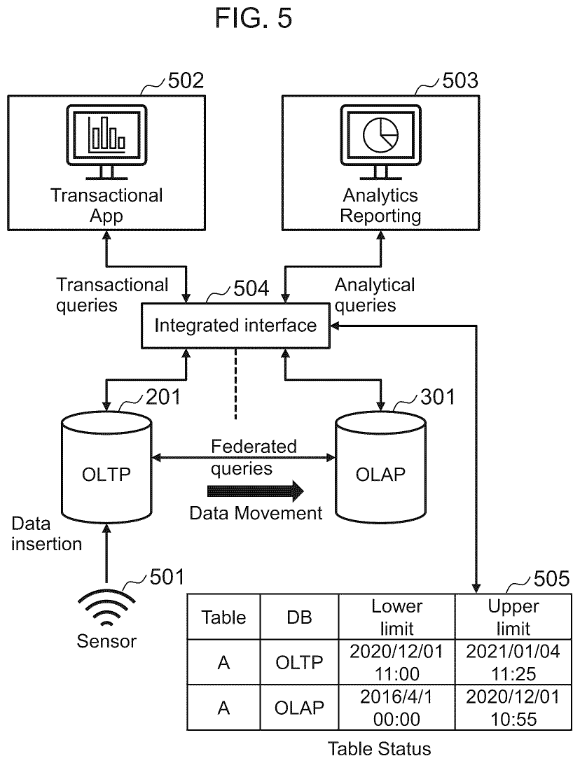

FIG. 5 is a diagram illustrating a schematic operation of the information processing system 1.

Here, a case in which, for example, data acquired from a sensor (Sensor) 501 used when production of a product is performed is written to the OLTP database 201 (Data Insertion), and the online transaction processing (OLTP) or the online analytical processing (OLAP) is performed on this data is considered.

When transactional queries occur, a transactional application (Transactional App) 502 queries the OLTP database 201 and performs this processing. On the other hand, when analytical queries occur, an analytics reporting application (Analytics Reporting) 503 queries the OLAP database 301 and performs this process. These processing are distributed by an integrated interface 504. This is done by the query type identification unit 108 in FIG. 4, for example.

Further, the integrated interface 504 performs movement of data from the OLTP database 201 to the OLAP database 301 (Data Movement). Further, the integrated interface 504 temporarily moves the data from the OLTP database 201 to the OLAP database 301 when federated queries have occurred. This is performed by the data movement unit 103 in FIG. 4.

Further, the data movement optimization apparatus 10 creates the table status 505. The table status 505 indicates the status of the OLTP database 201 or the OLAP database 301, and includes a recording period of the data as shown. In this case, the recording period of the data stored in each database (DB) is represented by a lower limit and an upper limit of a time when the data stored in each database has been generated. That is, the recording period of the data is a period between the lower limit and the upper limit. In this case, the recording period of the data stored in the OLTP database 201 is from 2020/12/01 11:00 to 2021/01/04 11:25. Further, the recording period of the data stored in the OLAP database 301 is from 2016/4/1 00:00 to 2020/12/01 10:55.

Description of Deep Machine Learning

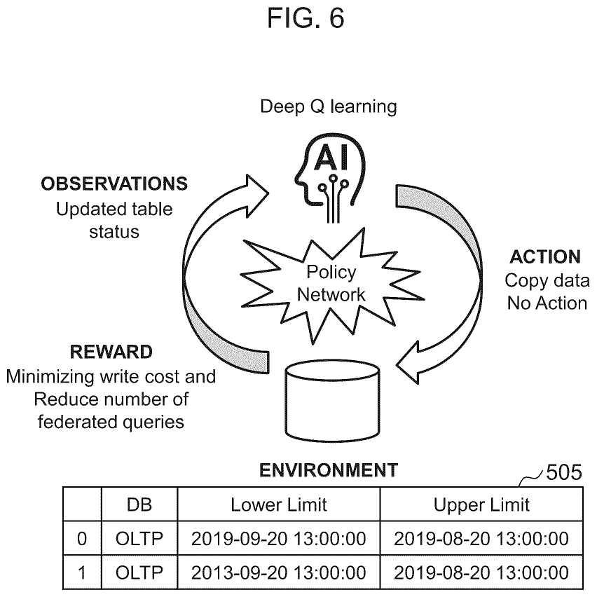

FIG. 6 is a diagram illustrating a procedure in which the data movement optimization apparatus 10 performs deep machine learning on the basis of the table status 505.

Here, the data movement optimization apparatus 10 performs deep machine learning (Deep Q learning) in the following three stages. The three stages are an action, a reward, and observation.

Action

The “action” is an example of a first stage, and either data is moved from the OLTP database 201 to the OLAP database 301 (Copy data) or the data is not moved (No Action). The table status 505 is considered as an environment at this time. Examples of the action may include moving all pieces of data, moving some of the pieces of data, or moving the data after a load on resources is reduced.

Reward

The “reward” is an example of a second stage, and a reward for the table status 505 determined by a result of the action is determined. This reward is determined by the number of federated queries and the cost. That is, the reward is set to increase as the number of federated queries decreases in a status of the table status 505. Further, the reward is set to increase as the cost decreases when data has been dynamically moved from the OLTP database to the OLTAP database at a predetermined timing. For example, the data movement optimization apparatus 10 assigns a positive reward when right action, such as moving data when the number of federated queries decreases or the cost is low, is performed. On the other hand, the data movement optimization apparatus 10 assigns a negative reward when a wrong action, such as moving data when the number of federated queries increases or the cost is high, is performed. It is possible to obtain the reward by inputting the number of federated queries and the cost to a predefined reward function. In deep machine learning, this reward learns a case in which a cost (especially, a high write cost) or the number of federated queries is minimized (Minimizing write cost and Reduce number of Federated queries). The data movement optimization apparatus 10 performs a determination to move data from the OLTP database 201 to the OLAP database 301 when the reward is estimated to increase, on the basis of the result of the learning and the table status 505.

Observation

The “observation” is an example of a third stage, and updates the table status 505 when the data has been moved from the OLTP database 201 to the OLAP database 301 (Updated table Status).

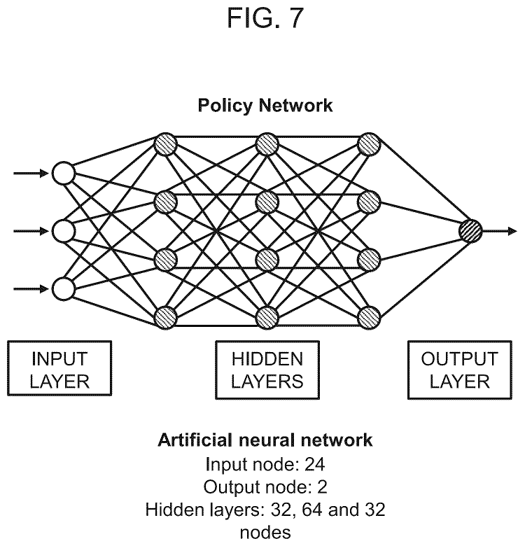

FIG. 7 is a diagram illustrating an artificial neural network that is used for deep machine learning.

In the illustrated artificial neural network, the number of nodes (Input nodes) of an input layer (INPUT LAYER) is 24, and the number of nodes (Output nodes) of an output layer (OUTPUT LAYER) is 2. Further, the number of hidden layers (HIDDEN LAYER) is 3, and the numbers of nodes thereof are 32, 64, and 32, respectively.

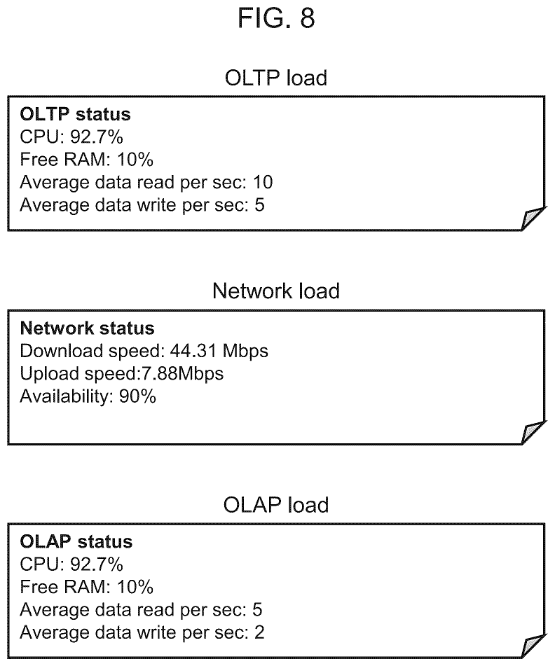

FIG. 8 is a diagram illustrating parameters that are used when the cost is obtained.

The cost is calculated on the basis of a load on resources that are used when data is moved from the OLTP database 201 to the OLAP database 301. These resources correspond to, for example, the CPUs 11 and 21, the storage devices 13 and 23, the network interfaces 14 and 24, the network 40, and the like in FIG. 1.

In FIG. 8, three loads including a load on the OLTP system 20 (an OLTP load) a load on the network 40 (a Network load), and a load on the OLAP system 30 (OLAP load) are illustrated. The loads on the OLTP system 20 and the OLAP system 30 are, for example, a CPU occupation rate (CPU), a free space of a RAM (Free RAM), an average read speed (Average data read per sec), an average write speed (Average data write per sec). Further, the load on the network 40 is a download speed, an upload speed, and availability.

Detailed Description of Action of Data Movement Optimization Apparatus 10

Next, a detailed description of the action of the data movement optimization apparatus 10 will be performed.

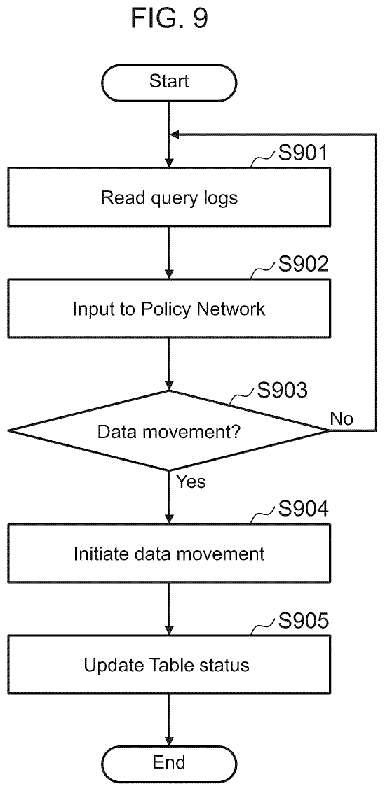

FIG. 9 is a flow chart illustrating the action of the data movement optimization apparatus 10 when data is moved from the OLTP database 201 to the OLAP database 301 using the policy network.

First, the policy network reads the logs of the query (Read query logs) (step S901).

Next, the policy network inputs the table status to the policy network (Input to Policy Network) (step S902).

The policy network decides whether or not a determination is made that movement of data is performed from the OLTP database 201 to the OLAP database 301 (Data movement?) (step S903).

As a result, when the policy network does not move the data (No in step S903), the processing returns to step S901.

On the other hand, when the policy network has determined movement of data (Yes in step S903), the movement of the data is initiated (Initiate data movement) (step S904).

Further, the policy network updates the table status (Update Table status) (step S905).

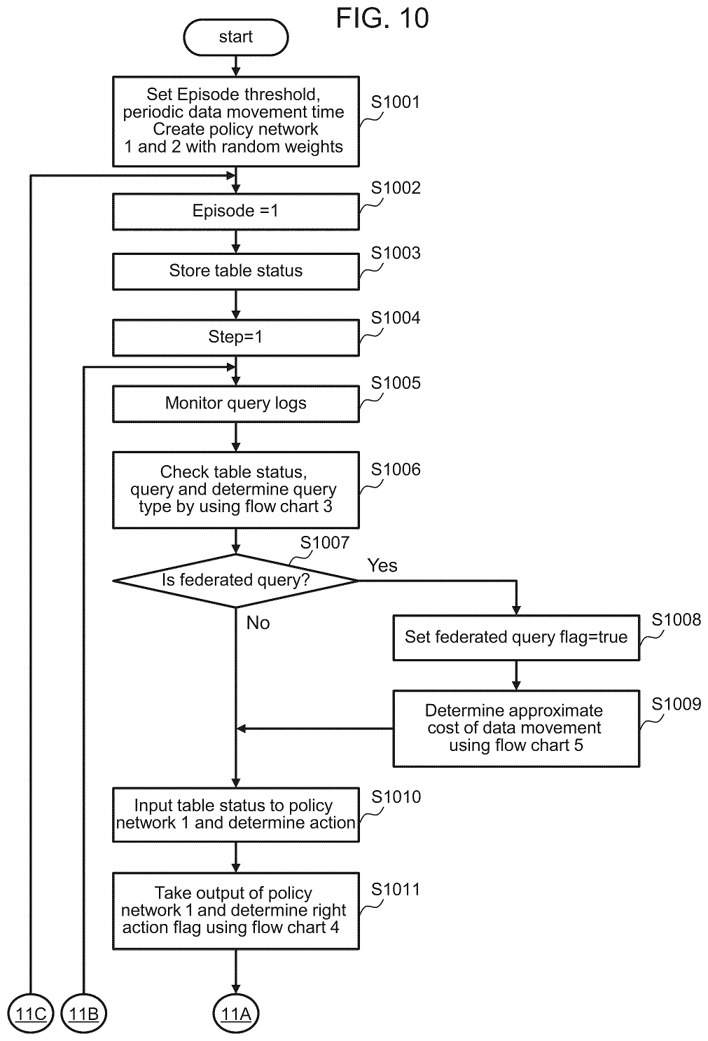

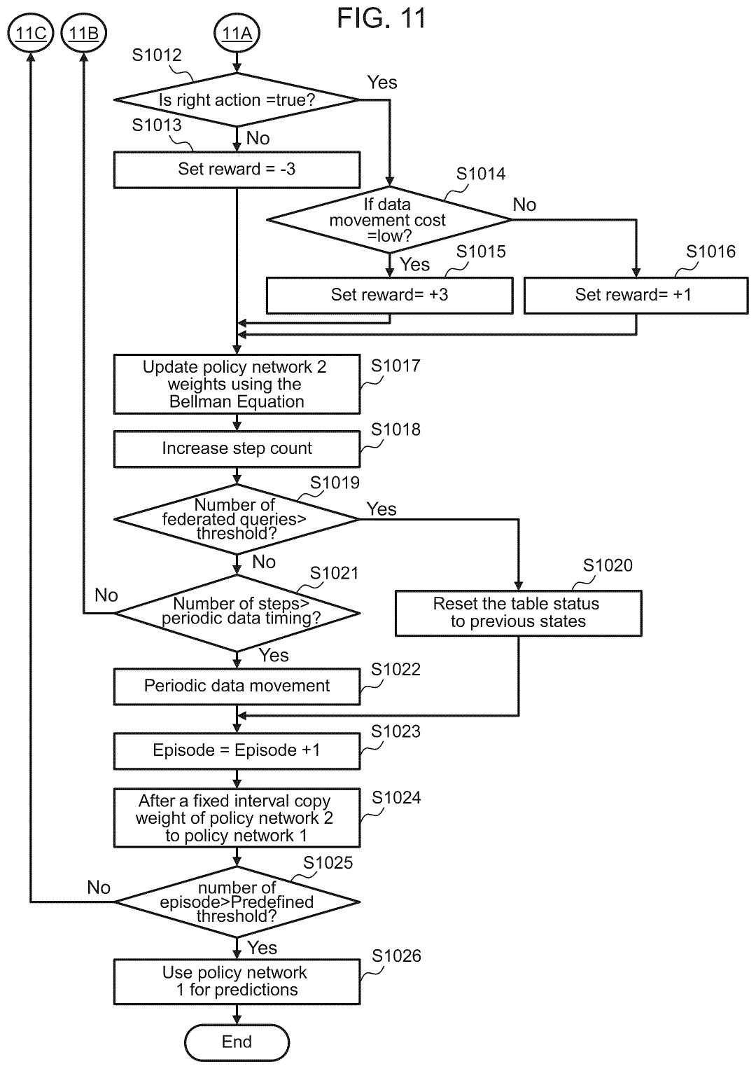

FIGS. 10 and 11 are flow charts illustrating a flow when the policy network performs learning. That is, FIGS. 10 and 11 are flow charts when a policy network is created. Here, movement of data is performed periodically, and in this situation, the policy network performs learning.

Here, step is the number of queries. When the step exceeds a predefined threshold, the movement of the data is performed periodically. Further, Episode indicates the number of times the data has been moved periodically.

First, the data movement optimization apparatus 10 sets a threshold of Episode and a time to periodically move data (Set Episode threshold, Periodic data movement time). Further, the data movement optimization apparatus 10 creates policy network 1 and policy network 2 with random weights (Create policy network 1 and 2 with random weights) (step S1001).

Next, the data movement optimization apparatus 10 sets Episode to 1 (Episode=1) (step S1002). That is, the data movement optimization apparatus 10 initializes the Episode.

Further, the data movement optimization apparatus 10 acquires the table status (Store table status) (step S1003).

Further, the data movement optimization apparatus 10 sets step to 1 (Step=1) (step S1004). That is, step is initialized.

The data movement optimization apparatus 10 monitors query logs (Monitor query logs) (step S1005).

Further, the data movement optimization apparatus 10 checks the table status and the query, and uses a flow chart 3 to be described below to determine a type of query (Check table status, query and determine query type by using flow chart 3) (step S1006).

Next, the data movement optimization apparatus 10 decides whether the type of query is a federated query (Is federated query?) (step S1007).

As a result, when the type of query is a federated query (Yes in step S1007), the data movement optimization apparatus sets the federated query flag to true (Set federated query flag=true) (step S1008). The data movement optimization apparatus 10 determines an approximate cost incurred for data movement by using flow chart 5 to be described below (Determine approximate cost of data movement using flow chart (step S1009). Thereafter, the processing proceeds to step S1010.

On the other hand, when the type of query is not the federated query (No in step S1007), the data movement optimization apparatus 10 inputs the table status to the policy network and determines the action (Input table status to policy network 1 and determine action) (step S1010). Next, the data movement optimization apparatus 10 acquires an output of policy network 1 and uses flow chart 4 to be described below to determine a flag indicating a right action (Take output of policy network 1 and determine right action flag using flow chart 4) (step S1011).

Further, the data movement optimization apparatus 10 decides whether this flag is true (Is right action=true?) (step S1012).

As a result, when this flag is not true (No in step S1012), the data movement optimization apparatus 10 sets the reward to −3 (Set reward=−3) (step S1013).

Further, when this flag is true (Yes in step S1012), the data movement optimization apparatus 10 decides whether a cost incurred for the movement of the data is low (If the data movement cost=low?) (step S1014).

As a result, when the cost is low (Yes in step S1014), the data movement optimization apparatus 10 sets the reward to +3 (Set reward=+3) (step S1015).

On the other hand, when the cost is not low (No in step S1014), the data movement optimization apparatus 10 sets the reward to +1 (Set reward=+1) (step S1016).

In other words, when the movement of the data is incorrect, a negative reward is assigned (the reward is −3 in the above-described case). Further, when the movement of the data is correct and the cost is low, a positive reward is assigned and a magnitude thereof is great (the reward is +3 in the above-described case). Further, if the cost is high even when the movement of the data is correct, a positive reward is assigned, but a magnitude thereof is small (the reward is +1 in the above-described case).

After the reward is set in steps S1013, S1015, and S1016, the data movement optimization apparatus 10 uses a Bellman equation to update the weights of policy network 2 (Update policy network 2 weights using the Bellman Equation) (step S1017). The Bellman equation is an equation that expresses requirements of optimality in mathematical optimization known as dynamic programming.

Next, the data movement optimization apparatus 10 increases the Step count (Increase step count) (step S1018).

The data movement optimization apparatus 10 decides whether or not the number of federated queries exceeds the threshold (Number of federated queries>threshold?) (step S1019).

As a result, when the number of federated queries exceeds the threshold (Yes in step S1019), the data movement optimization apparatus 10 resets the table status to a previous status (Reset the table status to previous status) (step S1020). Thereafter, the processing proceeds to step S1023.

On the other hand, when the number of federated queries does not exceed the threshold (No in step S1019), the data movement optimization apparatus 10 decides whether the number of Steps exceeds the timing at which the periodic movement of the data is performed (Number of steps>periodic data timing?) (step S1021).

As a result, when the number of federated queries does not exceed the threshold (No in step S1021), the processing returns to step S1005.

On the other hand, when the number of federated queries exceeds the threshold (Yes in step S1021), the data movement optimization apparatus 10 performs periodic movement of data (Periodic data movement) (step S1022).

The data movement optimization apparatus 10 increments Episode by +1 (Episode=Episode+1) (step S1023).

After a certain time has elapsed, the data movement optimization apparatus 10 copies a weight of policy network 2 to policy network 1 (After a fixed interval copy weight of policy network 2 to policy network 1) (step S1024). Next, the data movement optimization apparatus 10 decides whether the number of Episodes exceeds a predefined threshold (If number of episodes>predefined threshold?) (step S1025).

As a result, when the threshold is exceeded (Yes in step 1025), the data movement optimization apparatus 10 uses policy network 1 as a policy network for dynamically predicting the movement of the data (Use policy network 1 for predictions) (step S1026).

On the other hand, when the threshold is not exceeded (No in step S1025), the processing returns to step S1002.

Thus, the data movement optimization apparatus 10 obtains the reward for each query, and policy network 2 performs learning accordingly (step S1017). The data movement optimization apparatus 10 performs periodic movement of data when the step, which is the number of queries, exceeds a predefined threshold (steps S1021 and S1022). Further, when the number of federated queries exceeds a predefined threshold, policy network 2 returns to a previous status (steps S1019 and S1020). A weight of policy network 2 is copied to policy network 1 every certain time (step S1024). Further, here, a period from movement of data to movement of next data is defined as one Episode. When Episode exceeds the predefined threshold (step S1025), policy network 1 with the best result is generated and adopted as the policy network used in FIG. 9 (step S1026). That is, sequential update to a policy network with a smaller number of federated queries or a lower cost is performed, and a policy network with the smallest number of federated queries or the lowest cost is created.

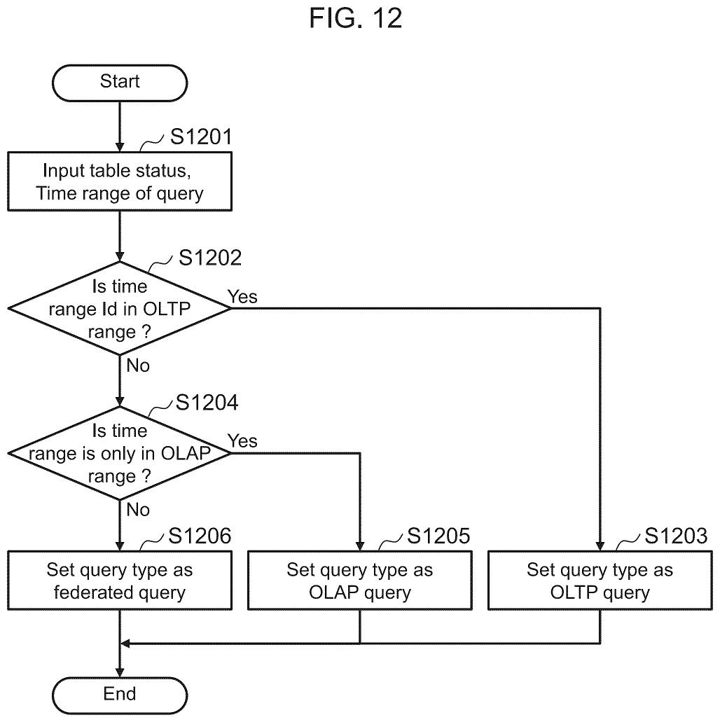

FIG. 12 is a diagram illustrating flow chart 3 of step S1006 in FIG. 10 in greater detail.

First, the data movement optimization apparatus 10 inputs the table status, and a time range requested by the query (Input table status, Time range of query) (step S1201).

Next, the data movement optimization apparatus 10 decides whether the time range is within the recording period of the OLTP database (Is time range Id in OLTP range) (step S1202).

As a result, when the time range is within the recording period of the OLTP database (Yes in step S1102), the data movement optimization apparatus 10 determines that the query type is an OLTP query (Set query type as OLTP query) (step S1203).

On the other hand, when the time range is not within the recording period of the OLTP database (No in step S1202), the data movement optimization apparatus 10 decides whether the time range is within the recording period of the OLAP database (Is time range id in OATP range) (step S1204).

As a result, when the time range is within the recording period of the OLAP database (Yes in step S1204), the data movement optimization apparatus 10 sets the query type as an OLAP query (Set query type as OLAP query) (step S1205).

On the other hand, when the time range is not within the recording period of the OLAP database (No in step S1204), the data movement optimization apparatus 10 sets the query type as the federated query (Set query type as federated query) (step S1206).

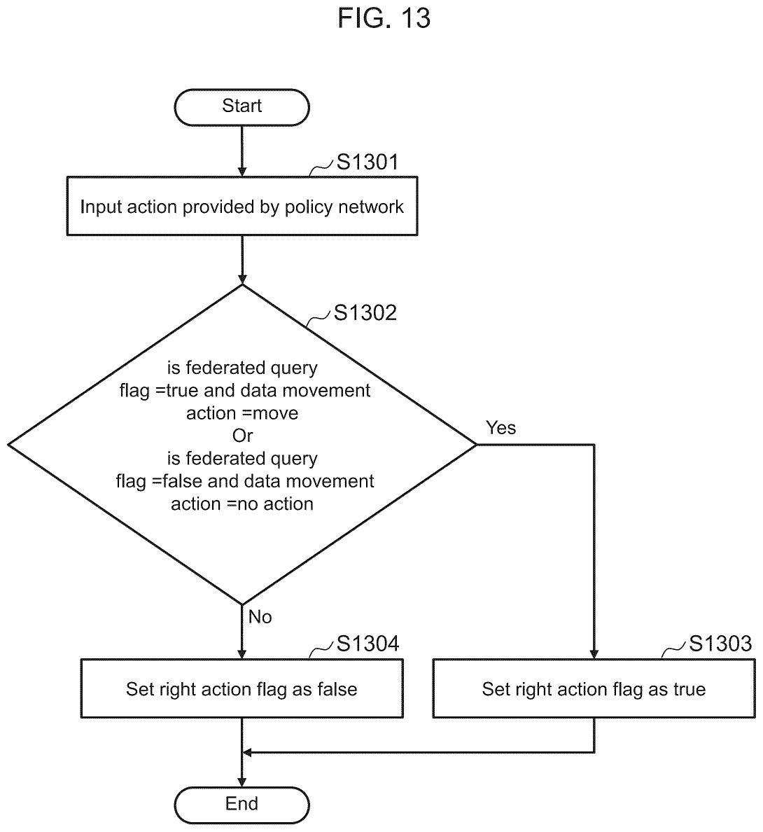

FIG. 13 is a diagram illustrating flow chart 4 of step S1011 in FIG. 10 in greater detail.

First, the data movement optimization apparatus 10 inputs the action created by the policy network (Input action provided by policy network) (step S1301).

Next, the data movement optimization apparatus 10 decides whether the federated query flag is correct (federated query flag=true) and whether the movement of the data has been performed (the data movement action=move) (is federated query flag=true and the data movement action=move?). Alternatively, the data movement optimization apparatus 10 decides whether the federated query flag is false (federated query flag=false) and the movement of the data has not been performed (the data movement actin=no action) (is federated query flag=false and the data movement action=no action?) (step S1302).

As a result, in the case of Yes in step S1302, the data movement optimization apparatus 10 sets the flag indicating a right action (right action flag) as true (Set right action flag as true) (step S1303).

On the other hand, in the case of No in step S1302, the data movement optimization apparatus 10 sets the flag indicating a right action (right action flag) as false (Set right action flag as false) (step S1304).

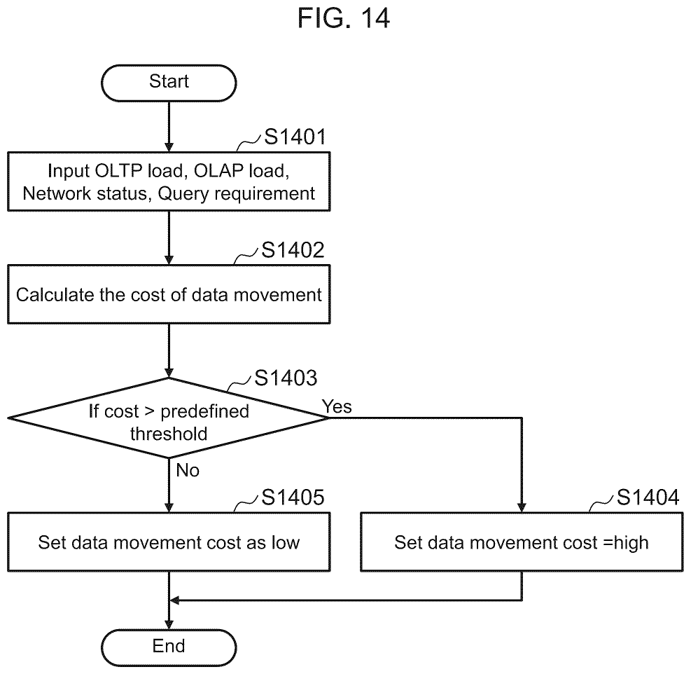

FIG. 14 is a diagram illustrating flow chart 5 in step S1009 of FIG. 10 in greater detail.

First, the data movement optimization apparatus 10 inputs the load on the OLTP system 20 (an OLTP load), the load on the OLAP system 30 (an OLAP load), the status of the network 40 (Network Status), and a requirement of the query (Query requirement) (Input OLTP load, OLAP load, Network Status, Query requirement) (step S1401).

Next, the data movement optimization apparatus 10 calculates the cost incurred for the movement of the data (Calculate the cost of data movement) (step S1402).

Further, the data movement optimization apparatus 10 decides whether or not the cost is greater than a predefined threshold (If cost>predefined threshold) (step S1403).

As a result, when the cost is greater than the predefined threshold (Yes in step S1403), the data movement optimization apparatus 10 sets the cost incurred for the movement of the data as high (Set movement cost=high) (step S1404).

On the other hand, when the cost is equal to or lower than the predefined threshold (No in step S1403), the data movement optimization apparatus 10 sets the cost incurred for the movement of the data as low (Set movement cost as low) (step S1405).

According to the data movement optimization apparatus 10 described above, it is possible to move the data stored in the OLTP database to the OLAP database so that the number of federated queries or the cost are reduced. This movement of the data is dynamically performed so that the number of federated queries or the cost are reduced depending on the status of each database. A movement timing is determined by a learning model learned by machine learning. That is, a rule for movement is automatically created by machine learning. Therefore, it is possible to reduce an effort of the database administrator to create the rule for moving the data stored in the OLTP database to the OLAP database.

Further, in the information processing system 1 described above, the databases may be two databases including the OLTP database and the OLAP database, but may be three or more databases. In this case, the present invention can be applied to a case in which movement of data between a plurality of databases selected from three or more databases is performed.

Description of Information Management Method

Here, the processing that is performed by the data movement optimization apparatus 10 can be regarded as an information management method for acquiring the table status 505 in which data is stored for each of the OLTP database and the OLAP database selected from among a plurality of databases, learning the number of federated queries that are processing in which it is necessary to query both the OLTP database and the OLAP database for the table status 505, and a cost incurred when data is moved from the OLTP database to the OLAP database, and performing control for moving data from the OLTP database to the OLAP database on the basis of the result of the learning and the table status 505.

Description of Computer-Readable Recording Medium Having Program Recorded Thereon

Further, the processing that is performed by the data movement optimization apparatus 10 in the present embodiment described above is realized by cooperation of software and hardware resources. That is, a processor such as a CPU provided in the data movement optimization apparatus 10 executes a program for realizing each function of the data movement optimization apparatus 10 to realize the functions.

Therefore, in the present embodiment, the processing that is performed by the data movement optimization apparatus can be regarded as a program for causing a computer to realize an acquisition function of acquiring the table status 505 in which data is stored for each of the OLTP database and the OLAP database selected from among a plurality of databases, a learning function of performing learning on the number of federated queries that are processing in which it is necessary to query both the OLTP database and the OLAP database for the table status 505, and a cost incurred when data is moved from the OLTP database to the OLAP database, and a movement function of performing control for moving data from the OLTP database to the OLAP database on the basis of the result of the learning and the table status 505.

The program that realizes the present embodiment can be not only provided by a communication means, but also stored in a recording medium such as a CD-ROM and provided. Therefore, the present embodiment can be regarded as a computer-readable recording medium on which the program is recorded.

Although the present embodiment has been described above, the technical scope of the present invention is not limited to the scope described in the above embodiment. It is clear from the description of claims that various changes or improvements made to the above embodiment are also included in the technical scope of the present invention.

What is claimed is:

1. An information management apparatus comprising:
an acquisition unit configured to acquire a status in which data is stored, for each of a first database and a second database selected from among a plurality of databases;
a learning unit configured to perform learning on the number of federated queries, the federated queries being processing in which it is necessary to query both the first database and the second database, and a cost incurred when data is moved from the first database to the second database, for the status; and
a movement unit configured to perform control for moving data from the first database to the second database on the basis of a result of the learning and the status.

2. The information management apparatus according to claim 1, wherein the learning unit performs machine learning on a reward determined by the number of federated queries or the cost.

3. The information management apparatus according to claim 2, wherein the learning unit performs machine learning including
a first step of performing either a movement or non-movement of data from the first database to the second database;
a second step of determining the reward for the status determined by a result of the first step; and
a third step of updating the status when data has been moved from the first database to the second database.

4. The information management apparatus according to claim 2, wherein the reward increases as the number of federated queries or the cost decreases.

5. The information management apparatus according to claim 4, wherein the movement unit performs movement when the reward is estimated to increase, on the basis of the result of the learning and the status.

6. The information management apparatus according to claim 1, wherein the cost is calculated on the basis of a load on resources that are used when data is moved from the first database to the second database.

7. The information management apparatus according to claim 1, wherein the status includes information on a recording period of data stored in each of the first database and the second database.

8. The information management apparatus according to claim 7, wherein the recording period is represented by a lower limit and an upper limit of a time when data stored in each of the first database and the second database has been generated.

9. The information management apparatus according to claim 1, wherein the first database is an OLTP database used when online transaction processing (OLTP) is performed, and the second database is an OLAP database used when online analytical processing (OLAP) is performed.

10. The information management apparatus according to claim 9, wherein the federated query occurs when analytical processing is performed on data stored in the OLTP database.

11. The information management apparatus according to claim 9, wherein the OLTP database and the OLAP database are used under a hybrid transaction analytical processing (HTAP) architecture.

12. An information management method comprising:
acquiring a status in which data is stored, for each of a first database and a second database selected from among a plurality of databases;
performing learning on the number of federated queries, the federated queries being processing in which it is necessary to query both the first database and the second database, and a cost incurred when data is moved from the first database to the second database, for the status; and
performing control for moving data from the first database to the second database on the basis of a result of the learning and the status.

13. A computer-readable recording medium having a program recorded thereon, the program causing a computer to realize:
an acquisition function of acquiring a status in which data is stored, for each of a first database and a second database selected from among a plurality of databases;
a learning function of performing learning on the number of federated queries, the federated queries being processing in which it is necessary to query both the first database and the second database, and a cost incurred when data is moved from the first database to the second database, for the status; and
a movement function of performing control for moving data from the first database to the second database on the basis of a result of the learning and the status.
